(19) United States
(12) Patent Application Publication
(10) Pub. No.: US 2019/0311700 A1
(43) Pub. Date: Oct. 10, 2019

(54) Drum Wah

(71) Applicant: Lawrence Jin-Sung Ham, Anna, TX (US)

(72) Inventor: Lawrence Jin-Sung Ham, Anna, TX (US)

(21) Appl. No.: 15/237,483

(22) Filed: Aug. 15, 2016

(51) Int. Cl. G10D 13/02

(52) U.S. Cl. CPC G10D 13/021; G10D 13/027

(57) ABSTRACT

A drum and pitch adjustment device for a drum includes a drum with a sound producing membrane, a device for applying pressure to the sound producing membrane, and a cable configured to the device for applying and releasing pressure to the sound producing membrane, changing the pitch of the drum, but goes back to the drum's original pitch when absent this force. A hand operated lever, located on the side of the drum, operates the cable which makes the pressure device push up against the sound producing membrane and changing it's pitch. Absent this force, the drum goes back to its original pitch, which creates different tonal variety when played in real-time.

### CROSS-REFERENCE TO RELATED APPLICATION

The present application is continuation in part of application Ser. No. 14/708,418, filed May 11, 2015, and invented by Lawrence Jin-Sun Ham.

### FIELD OF THE INVENTION

The present invention is directed to a drum (percussion instrument) that bends the pitch.

### BACKGROUND OF THE INVENTION

Percussion drums are usually tuned so that have a single pitch. The pitch of the drum is changed by tightening and loosening the head of the drum.

### SUMMARY OF THE INVENTION

In one embodiment, the present invention, a drum wah lever (that is hand operated) that changes the tone of the sound off of the drum head (percussion instrument) during real-time playing.

### DESCRIPTION OF THE DRAWINGS

FIG. 1 illustrates the device for applying pressure to the sound producing membrane.

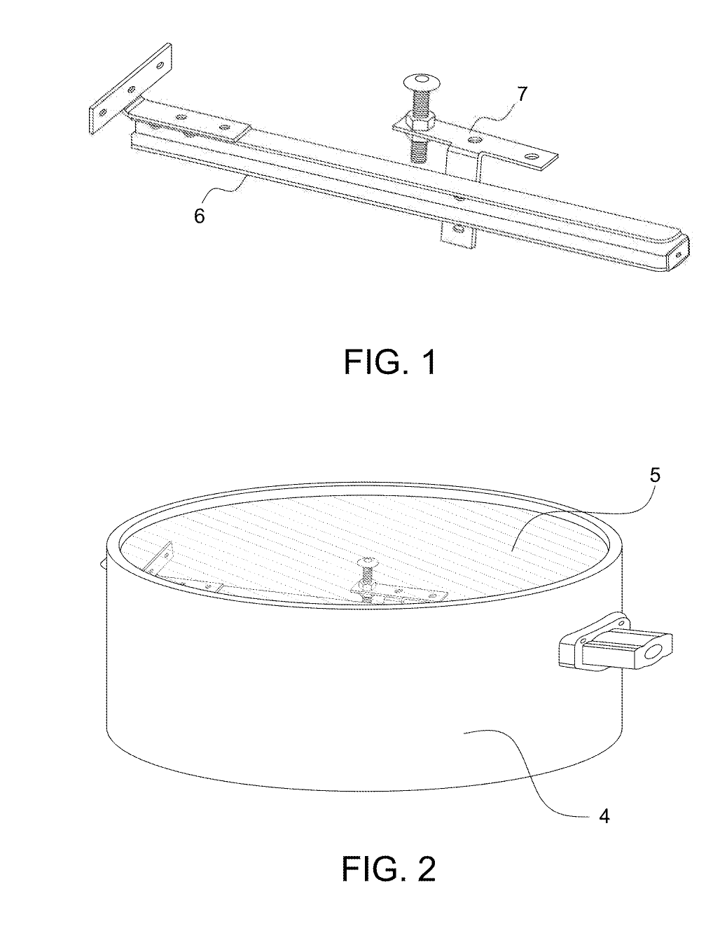

FIG. 2 illustrates the device when it is placed within the drum for operation.

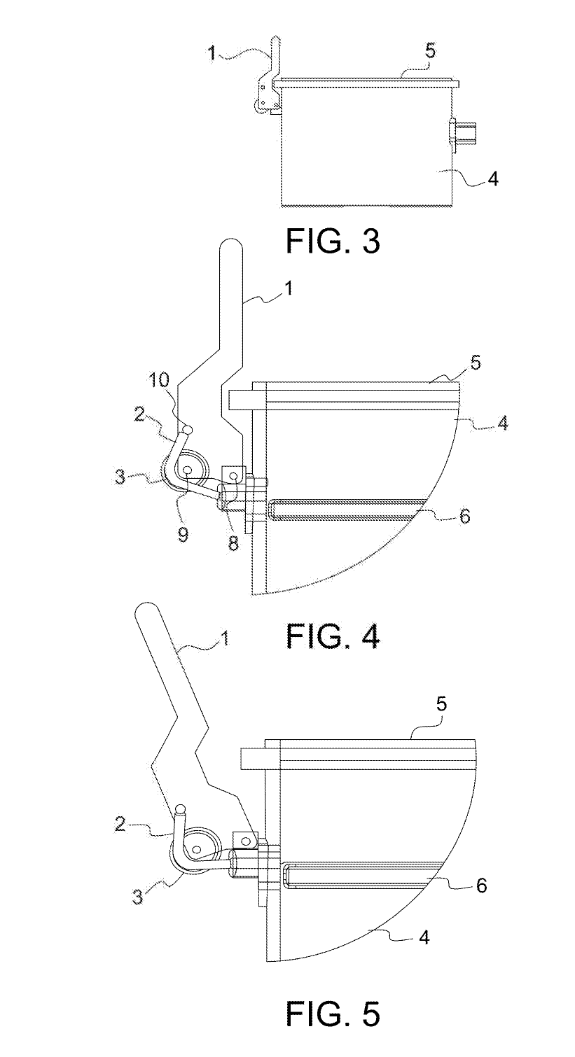

FIG. 3 through FIG. 9 illustrate, in further detail, the device inside the drum; as well as the lever and the cable (which is connected from the outside to the lever, and runs into the drum), included in the device.

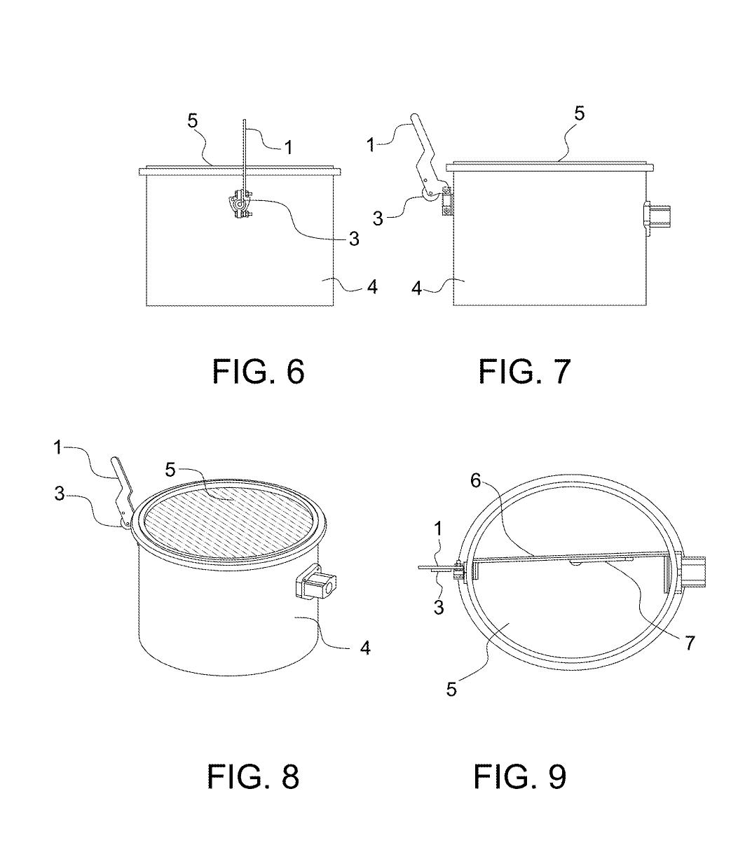

### DETAILED DESCRIPTION OF THE INVENTION

A device for adjusting the tone and pitch drum, uses a pressure device (7) adapted to engage the sound producing membrane (5) of a drum (4) and is operated by a tension mechanism (3). The tension mechanism may be operably engaged by a cable (2) to provide pressure to the sound producing membrane of a drum. The cable may be of the form of a string (or a wire which is attached to a lever (1) from the outside and runs through the drum and attached to the pressure device (7), which is represented as a hinged post that will be inside the drum), to provide movement of the device applying pressure to the sound producing membrane of a drum. The cable may be moved by the musician manually or with the aid of a hand operated lever (1) while the drummer is playing. When absent of this force the drum goes back to it's original pitch.

The movement of the wire or string (which is connected to the lever, from the outside), applies and releases pressure on the sound producing membrane of a drum to provide a method of continuously varying the tone and pitch during play. The pressure device (7) shall be inside of the drum shell and operably moved by a cable and/or lever that extends outside, and on the side of the drum shell. As pressure is applied to the sound producing membrane the pitch increases. As pressure is withdrawn from the sound producing membrane the pitch decreases. The pitch may be varied by quickly applying and releasing pressure to the drum, while the drummer is playing.

FIG. 4 shows a hinge point (8), a roller attachment (9), and a string tie point (10).

What is claimed is:

1. A drum and pitch adjustment device for a drum comprising:
a drum with a sound producing membrane;
a device for applying pressure to the sound producing membrane; and
a cable configured to the device for applying and releasing pressure to the sound producing membrane, changing the pitch of the drum, but goes back to the drum's original pitch when absent this force.

2. A drum and pitch adjustment device as described in claim 1 where a hand operated lever, located on the side of the drum, operates the cable which makes the pressure device push up against the sound producing membrane and changing it's pitch; when absent his force, the drum goes back to its original pitch, which creates different tonal variety when played in real-time.
